(19) United States
(12) Patent Application Publication
(10) Pub. No.: US 2007/0217120 A1
(43) Pub. Date: Sep. 20, 2007

(54) Microelectrical Device With Space Charge Effect

(76) Inventors: Jean-Michel Sallese, Pully (CH); Didier Bouvet, Morges (CH)

Correspondence Address: STURM & FIX LLP, 206 SIXTH AVENUE, SUITE 1213, DES MOINES, IA, 50309-4076, US

(21) Appl. No.: 11/685,369

(22) Filed: Mar. 13, 2007

(30) Foreign Application Priority Data
Mar. 15, 2006 (IB) PCT/IB06/50808

(51) Int. Cl. H01G 5/01

(52) U.S. Cl. 361/278

(57) ABSTRACT

A microelectrical device comprising two generally parallel electrodes (20,21) at least one of which is movable, and at least one of the electrodes comprising a layer of a semiconductor presenting space charge characteristics. The electrodes have a closed position an open position. A spring effect biases the movable electrode (21) towards the open position. When the movable electrode (21) is closed by a first voltage pulse (P1) a sufficiently high space charge density (10) is generated to hold the movable electrode (21) closed. When zero voltage is applied the movable electrode (21) is held closed by the built in space charge until the application of a second voltage pulse (P2) which decreases the space charge in the semiconductor (10) to allow the movable electrode(s) to be moved to the open position by the spring effect.

### TECHNICAL FIELD

This invention relates to microelectrical devices in particular those known as MEMS or Micro-Electro-Mechanical Systems. It proposes a novel microelectrical device which can be used inter alia as switchable capacitor, as actuator for the actuation of an electrical devices, such as electrical DC or RF switches and capacitors, as position actuator for optical (micro) mirrors and (micro) shutters, as tunable capacitor in open or in closed mode when a DC voltage is superimposed to the signal, or as RF switch, as a micromechanical memory cell.

### BACKGROUND ART

During the past few years there has been considerable interest in switch and RF MEMS since they represent a very interesting alternative to conventional microelectronic devices where high quality factors and ideal electrical contacts are required. In addition, a major advantage of MEMS structures is that they can be designed and fabricated by techniques similar to those of large-scale integration of silicon technology. An overview of such devices with a detailed description of the various approaches can be found in: J. J. Yao, RF MEMS from a device perspective, J. Micromech. Microeng. 10 (2000) R9-R38; G. Rebeiz, J. B. Muldavin, RF MEMS switches and switch circuits, IEEE Microwave Mag. 2 (2001) 59-71.

A conventional MEMS structure comprises a dielectric layer disposed between two generally parallel electrodes at least one of which is movable, forming a parallel capacitor structure whose plates can be parallel or perpendicular to the substrate surface.

Bistable microrelays with mechanical bistability are known, for example thermally actuated bistable microrelays with a flexible mechanically-bistable double beam that can carry currents up to several amperes when closed, stand off voltages up to several hundreds of volts when open and that switch between their closed and open states in milliseconds (Jin Qiu, et. al. “A Curved-Beam Bistable Mechanism”, Journal of MEMS, vol. 13, no. 2, pp. 137, 2004; Jin Qiu et.al. “A high-current electrothermal bistable MEMS relay”, in Proceeding of the MEMS conference, pp. 64-67, 2003 and L. Que, et.al. “A bi-stable electro-thermal RF switch for high power applications”, in Proc. IEEE MEMS 2004 Conference, pp. 797-800). Magnetically actuated bistable microrelays are also known, but these require an actuating coil and the application of high currents (C. Dieppedale et. al. “Magnetic bistable micro-actuator with integrated permanent magnets”, in Proceedings of IEEE Sensors, vol. 1, pp. 493-496, 2004 and H. Rostaing, et.al. “Magnetic, out-of-plane, totally integrated bistable micro actuator”, in Proceedings of the 13th International Conference on Solid-State Sensors, Actuators and Microsystems, vol. 2, pp. 1366-1370, 2005).

There is however a need for such structures that have lower power consumption and that have improved switching performance.

### SUMMARY OF THE INVENTION

The invention provides a microelectrical device comprising two generally parallel electrodes at least one of which comprises a layer of a semiconductor material presenting space charge characteristics. The electrodes have a closed position where the electrodes come into contact and can also be covered by an insulating layer, and an open position in which the or each movable electrode is spaced from the other electrode by a gap. The movable electrode(s) is biased towards the open position by a spring effect. The electrodes are connectable to a voltage source for applying: a first voltage pulse to move the movable electrode(s) from the open to the closed position against the action of the biasing means, a low or zero voltage, and a second voltage pulse of opposite polarity to the first voltage pulse. When the or each movable electrode is moved to the closed position by the application of a first voltage pulse, a space charge is generated in the semiconductor to hold the electrodes in contact in closed configuration, and when the low or zero voltage is applied the or each movable electrode is held in the closed position by the charge that builds up inside or at the surfaces of the electrodes due to their difference in work function, until the application of the second voltage pulse decreases the built-in space charge to allow the movable electrode(s) to be moved to the open position by the action of the biasing means.

The invention thus provides a MEMS or Micro-Electro-Mechanical System that consists in two electrodes that can move with respect to one another, one of which includes a semiconductor exhibiting space charge characteristics.

The distance between the electrodes can be modified by applying a voltage whose effect is to create an attractive electrostatic force between the conductive electrode plates. The MEMS of the invention can be used as a variable capacitor or as a switch.

The role of the semiconductor layer is to introduce a memory effect through the built-in charge that characterizes semiconductor junctions and heterojunctions such as metal-semiconductor interfaces. Charges created in the electrodes after the electrodes are brought into contact will remain even after the potential has dropped to zero. As a consequence it is possible to maintain a certain amount of electrical charge on the electrodes that in turn will generate an attractive force that will keep the electrodes in contact. By reversing the applied potential, it is then possible to decrease the built-in charges on the electrodes that will separate.

Thus the device can be put in two stable states without any applied voltage (in the stable states). Further details of the theory underlying the inventive device and its operation are published in the article “Principles of space-charge based bistable MEMS: The junction MEMS”, Sensors and Actuators A133, pages 173-179, 2007.

The device according to the invention has the following advantages:
It has low power consumption.
It provides reconfigurable switch matrices.
Its active area can be used to actuate other mobile parts situated outside the region where the semiconductor layer is located.
The device can be used as an actuator with bistability in its displacement.
The device can be used as a micromechanical memory cell.
Since depletion regions on the electrodes surfaces are free of mobile carriers, such structure can also be used to prevent charge injection in the insulators when electrodes come into contact.

### BRIEF DESCRIPTION OF DRAWINGS

The invention will be further described by way of example with reference to the accompanying drawings in which:

FIG. 1 is a schematic representation of a device according to the invention in its open position;

FIG. 2 is a diagram illustrating the application of voltage pulses to a device according to the invention, with an indication of the corresponding position of the device;

FIG. 3 is a schematic diagram illustrating the structure of a device according to the invention produced by integrated silicon technology;

FIGS. 4a to 4e schematically illustrate steps of a process for the manufacture of a device like that of FIG. 3;

FIG. 4f is a top plan view of the finished device; and

FIG. 5 is a schematic representation of a device according to the invention which has an arrangement to maintain the semiconductor surfaces in depletion mode whatever be the applied voltage.

### DETAILED DESCRIPTION

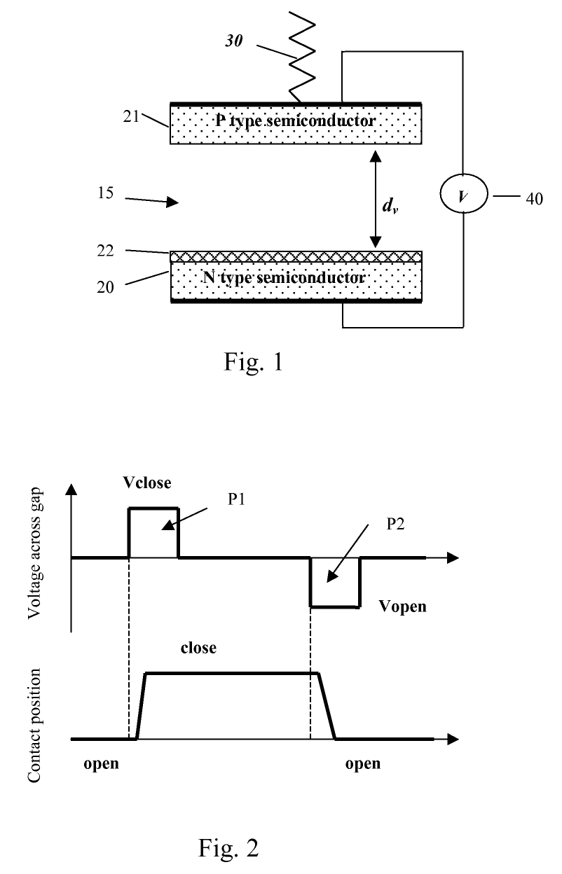

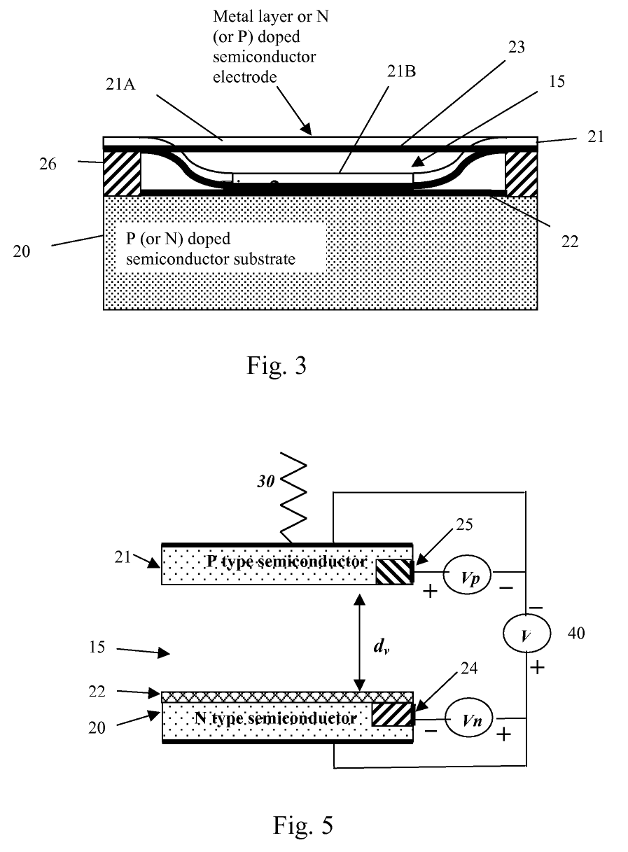

FIG. 1 schematically illustrates a microelectrical device according to the invention comprising two generally parallel electrodes 20,21 one of which at least comprises a layer of a semiconductor material presenting space charge characteristics. In the illustrated example, electrode 20 comprises a layer of an n type semiconductor and electrode 21 comprises a layer of a p type semiconductor. One or both of the facing sides of these semiconductor layers 20, 21 are optionally covered by thin insulating layer 22 (or 23, see FIG. 3). The role of the insulating layer(s) is twofold: to prevent any current to pass through the electrodes when the junction is forward biased, and to allow for using the MEMS as a capacitor.

The electrodes 20 and 21 are movable together and apart; for example electrode 20 is fixed and electrode 21 is movable. The electrodes 20,21 have a closed position in which the insulating layer 22 applies against the electrode 21 (optionally also with an insulating layer 23) and an open position (shown in FIG. 1) in which the movable electrode 21 is spaced from the opposite electrode 20 by an air (or vacuum) gap 15. A spring 30 or like means biases the movable electrode 21 towards the open position. The electrodes are shown connected to a voltage source 40 for applying a voltage V to the electrodes 20,21.

As shown in FIG. 2, the voltage source 40 can apply to the electrodes 20,21 a first voltage pulse P1 to move the movable electrode 21 from the open to the closed position against the action of spring 30, then a low or zero voltage, and a second voltage pulse P2 of opposite polarity to the first voltage pulse P1. When the movable electrode 21 is moved to the closed position by the application of the first voltage pulse P1, a space charge is created in the semiconductor layers that is sufficient to hold the movable electrode 21 against the opposite electrode 20. Then when the zero voltage is applied the movable electrode 21 is held in the closed position by the space charge of the semiconductors until the application of the second voltage pulse P2 which decreases the space charge to allow the movable electrode 21 to be moved to the open position by the action of the spring 30.

The microelectrical device shown in FIG. 1 has a parallel capacitor structure, of which at least one of the electrodes 20,21 is movable and held in position by a biasing means 30. The device is actuated by the Maxwell force to close the air or vacuum gap(s) 15 by an applied voltage pulse P1 (see FIG. 2) in such a way that a space charge is generated in the semiconductor material as well as in the other electrode. When the voltage is decreased to zero, the charge remains in its remanent state which keeps the compensating charges in the electrodes 20,21. These electrodes provide the necessary electrostatic (or Maxwell) force to keep the microelectrical device closed. The opening of the device is achieved by a suitable voltage pulse P2 of opposite polarity (see FIG. 2) in order to decrease the space charge density to almost zero, thus liberating the charges on the electrodes 20,21, and the movable electrode 21 flips back due to the elastic pulling force of the biasing means (spring 30) which can be established in a resilient structure holding the movable electrode 21. This device exhibits bistable operation characteristics as depicted in FIG. 2, because it can remain at rest in its closed or its open position without applying a voltage, i.e. voltage pulses need only be applied to make the device change state from open to closed or closed to open.

When only one of the electrodes has a semiconductor layer, the other electrode can be made of any suitable electrically conductive material that allows a space charge to be generated in the semi-conductor at the conductor/semi-conductor interface. In particular, the other electrode can be made of metal.

FIG. 3 schematically illustrates the structure of an embodiment of the device according to the invention produced by integrated silicon technology, and wherein a p or n doped semiconductor substrate that forms the first electrode 20, and optionally coated with a dielectric layer 22, supports a structural element 26 which in turn supports a flexible metallic or semiconductor membrane that forms the movable electrode 21, shown at 21A in its open position and at 21B in its closed position. In the open position the metallic or semiconductor membrane 21 is held stretched between the edges of the structural element 26. This element 26 can also serve as insulator between electrode 21 and electrode 20. When the first voltage pulse P1 is applied, the central part of the flexible metallic membrane is elastically deformed into the air-gap 15 to come to apply against the opposite semiconductor layer, as shown at 21B. The device then remains closed as long as zero voltage is applied. When the second voltage pulse P2 is applied, the central part of the metallic membrane returns to the open position 21A by the resilience of the membrane due to a lowering in the space charge density.

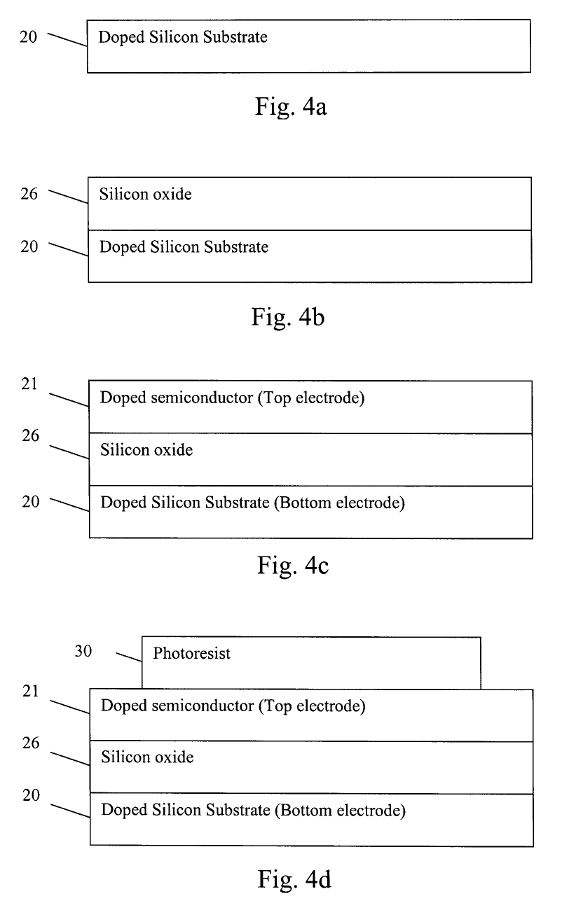

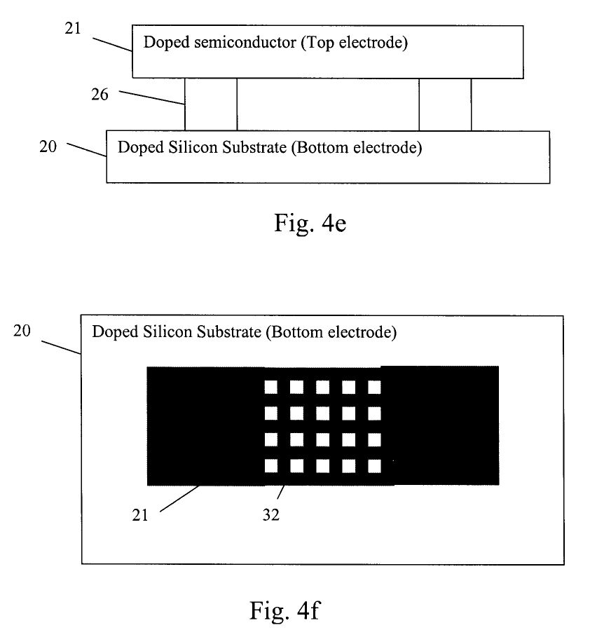

FIGS. 4a to 4e schematically illustrate the manufacturing of the device in cross section. The finished device is shown in top view in FIG. 4f. The starting material is a p or n doped semiconductor substrate, for example silicon, that will act as the bottom electrode 20 (FIG. 4a). A dielectric layer 26 is deposited on the starting material 20 (FIG. 4b). This dielectric material can for example be selected from dioxide (like SiO₂), polyimide, nitride, photoresist or equivalent materials. Then a second n or p doped semiconductor layer is deposited (that will form the top electrode 21) and patterned using conventional lithographic and etching techniques used in semiconductor processing (FIGS. 4c and 4d) using the usual layer of photoresist 30. The gap between the electrodes 20,21 is created by an isotropic etching of the dielectric layer 26 (FIGS. 4e and 4f). FIG. 4f shows optional processing holes 32 in the top electrode 21 that serve to remove materials from the gap, during processing. These processing holes 32 may also contribute to the flexibility of the central part of top electrode 21. Either or both electrodes 20,21 may be covered by a thin dielectric layer (not shown on FIGS. 4a to 4f, but shown at 22 in FIG. 1 and at 22,23 in FIG. 3).

The above-quoted materials are given by way of example and other materials with similar properties can be used.

The device preferably comprises at least one semiconductor layer with a typical doping density in the range from 1.10¹⁵ cm⁻³ to 1.10²¹ cm⁻³ usually higher than 1.10¹⁵ cm⁻³ in case of p or n doped silicon, which condition ensures that there will be two stable states at zero applied voltage.

As shown in FIG. 4, the electrodes are integrated from a semiconductor wafer having a generally planar surface, and the electrodes are disposed parallel to the planar surface of the wafer. Alternatively, the electrodes could be disposed perpendicular to the planar surface of the wafer.

Depending on whether or not there is an insulating layer that covers one or both of the electrodes there can be effects related to parasitic charge injection. We will distinguish two cases:

In the case where neither of the electrodes is covered by an insulating layer, the situation corresponds to the structure depicted on FIG. 1 but without the insulating layers 22 and 23. The device operates in reverse biased mode, i.e. with positive potential on the N doped layer and negative potential on the P doped layer. Due to the lack of insulating layer and since the depletion regions are almost empty of mobile charges that are swept-out by the electric field in that region, this structure will not suffer from fixed charge injection. However, when the electrodes are in contact, even if there is no insulator(s) in between, the depletion region acts as an insulating region and will then prevent any current flow across electrodes, in contrast with metallic based structures. Thus, this structure behaves like a metallic based electrostatic MEMS with insulating layers (no current across electrodes when these are in contact), but without a problem of undesirable charge injection.

Particularly in the case where at least one electrode is covered by an insulating layer, it is advantageous to avoid charge injection in the insulating layer by adopting a slightly different design, illustrated in FIG. 5.

The principle underlying the FIG. 5 configuration is to maintain the semiconductor surfaces in depletion mode whatever the applied potential V, by applying a special polarity as shown on FIG. 5 (corresponding to depletion). The goal is to almost cancel the minority carrier densities at the semiconductor surfaces in order to avoid any undesirable charge injection in the insulator(s) when the electrodes come into contact. Indeed, such effect could generate undesirable hysteresis and shifts in electromechanical device parameters that should be avoided for specific applications. This can be obtained by adding an N type diffusion 25 in the P type electrode and a P type diffusion 24 in the N type electrode, and then applying sufficiently high potentials Vn and Vp, as shown on FIG. 5. This will avoid the formation of a mobile carrier density at the electrodes' bare surfaces by decreasing minority carrier concentrations at their surfaces. Consequently, the electrodes will always remain depleted on their surface, even for large values of V.

Thus, this arrangement—which is applicable when one or both or neither of the electrodes is coated with an insulating layer—comprises means to maintain the semiconductor surfaces in depletion mode, namely a p-type diffusion area in a main n-type semiconductor layer of the electrode, or an n-type diffusion area in a main p-type semiconductor layer of the electrode, or both, and the or each diffusion area is associated with means for applying a biasing potential to maintain the surface of the main semiconductor layer in depletion mode.

This microdevice according to the invention can be used directly as switchable capacitor. The AC signal is conducted through the high capacity of the closed device. For use as a capacitor, one or both of the electrodes is optionally coated with a dielectric layer.

This microdevice according to the invention can also be used as actuator for the actuation of electrical devices, such as electrical DC or RF switches and capacitors.

This microdevice can also serve as optical device such as a position actuator for optical (micro) mirrors and (micro) shutters.

This device can also serve as tunable capacitor in the closed mode when a DC voltage is superimposed to the signal thus behaving like a simple varactor.

The device can also be used as a memory device.

The device is mainly useful in the micrometer range and can also be useful for macroscopic applications (dimensions up to several mm).

The device can be used as deformable mirrors, deformable gratings.

The device can be used as bistable pixels in displays.

The device can be used as controllable arrays of varicaps.

The device can be used as threshold-based pressure sensors.

The device can also be used to prevent charge injection in insulating layers during/after electrode sticking.

1. A microelectrical device comprising two generally parallel electrodes -at least one of which is movable, and at least one of the electrodes comprising a layer of a semiconductor material, the electrodes having a closed position in which they are together and an open position in which the electrodes are spaced by a gap, and means for biasing the movable electrode(s) towards the open position, the electrodes being connectable to a voltage source for applying:
a first voltage pulse to move the movable electrode(s) from the open to the closed position against the action of the biasing means,
a low or zero voltage, and
a second voltage pulse of opposite polarity to the first voltage pulse;
such that when the or each movable electrode is moved to the closed position by the application of a first voltage pulse a space charge is generated in the semiconductor to hold the electrodes in contact, and when said low or zero voltage is applied the or each movable electrode is held in the closed position by the space charge until the application of the second voltage pulse which decreases the space charge to allow the movable electrode(s) to be moved to the open position by the action of the biasing means.

2. The microelectrical device of claim 1 wherein one electrode comprises a layer of a p (or n) type semiconductor and the other electrode comprises a layer of an n (or p) type semiconductor or of a metal.

3. The microelectrical device of claim 1 wherein the electrodes are integrated from a semiconductor wafer having a generally planar surface, and the electrodes are parallel to or perpendicular to said planar surface of the wafer.

4. The microelectrical device of claim 1 comprising at least one semiconductor layer covered by an outer insulating layer.

5. The microelectrical device of claim 1 further comprising means to maintain surfaces of the semiconductor layers in depletion mode whatever be the applied potential.

6. The microelectrical device of claim 5 wherein the means to maintain the semiconductor surfaces in depletion mode include a p-type diffusion area in a main n-type semiconductor layer of the electrode, or an n-type diffusion area in a main p-type semiconductor layer of the electrode, or both, and the or each diffusion area is associated with means for applying a biasing potential to maintain the surface of the main semiconductor layer in depletion mode.

7. The microelectric device of claim 1 comprising at least one semiconductor layer of p or n doped silicon with a doping density in the range from 1.10¹⁵ cm⁻³ to 1.10²¹ cm⁻³.

8. The microelectrical device of claim 1 which is a capacitor.

9. The microelectrical device of claim 8 which is an RF capacitor.

10. The microelectrical device of claim 1 which is a switch.

11. The microelectrical device of claim 10 which is a bistable switch that remains open or closed as long as no voltage pulse is applied.

12. The microelectrical device of claim 10 which is an RF switch.

13. The microelectrical device of claim 1, which is a position actuator for optical micromirrors or shutters.

14. The micromechanical device of claim 1 which is a micro-relay that actuates another contact for passing a signal current.

15. The micromechanical device of claim 1 comprising a movable electrode made as a resilient flexible membrane that is biased towards the open position by the resiliency of the membrane.

16. The micromechanical device of claim 1 which is incorporated in a deformable mirror, a deformable grating, a display comprising bistable pixels formed by the device, an array of varicaps, or a threshold-based pressure sensor.
